(19) United States
(12) Patent Application Publication
(10) Pub. No.: US 2009/0063339 A1
(43) Pub. Date: Mar. 5, 2009

(54) SYSTEM AND METHOD FOR LOADING PREPAID DEBIT CARD AT AN ATM

(75) Inventor: Melissa M. Santora, Paradise Valley, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/850,579

(22) Filed: Sep. 5, 2007

(51) Int. Cl. G06Q 40/00

(52) U.S. Cl. 705/41

(57) ABSTRACT

Money is loaded onto prepaid debit cards at ATMs (without the use of clerk-assisted POS terminals). The network for processing transactions includes a debit/credit network with a ATM Load BIN table, which includes transaction permitted (TP) data associated with each bank identification number (BIN) appearing in the card number of the prepaid cards. If a load transaction is requested, the transaction is permitted and passed by the debit/credit network to the card issuer only if the TP data reflects that such a transaction is permitted.

### CROSS-REFERENCES TO RELATED APPLICATIONS

Not applicable

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK.

Not applicable

### BACKGROUND OF THE INVENTION

Prepaid debit cards have become widely used by some consumers as a convenient way to conduct electronic card transactions at merchants without having to use a traditional credit card. A prepaid debit card is established by depositing money in an associated stored value account maintained by the card issuer (usually a bank or other institution affiliated with a bank). However, the stored value account is not a traditional banking account (savings or checking account) and very little, if any, cardholder identification is kept by the issuer. In some cases, the cardholder identification may be nothing more than a PIN, which may be required from the cardholder (for authentication) when the card is used to conduct transactions. In other cases, the issuer may have minimal cardholder information, such as the name and address of the cardholder. Since there is no banking account, a prepaid debit card (and its underlying stored value account) does not have deposited money insured by the government through the Federal Deposit Insurance Corporation (FDIC) or any other public agency. Prepaid debit cards are thus distinguishable from traditional bank debit cards, which are issued by a financial institution in order to access an actual banking (checking or savings) account.

A prepaid debit card is typically “branded” with a major credit card name (such a VISA® or MASTERCARD®) and can be used at any merchant that accepts such credit cards. Because deposited money is used to conduct transactions, no credit is being extended. Thus, as examples, the card may be used by consumers without good credit history, or by teenagers whose parents want to provide the convenience of credit card but without the risk of overuse and overspending. In some cases prepaid debit cards may also be used to make cash withdrawals (for some or all of the deposited amount). Although the cards are usually issued by a bank, they can be loaded or reloaded by the cardholder (have money deposited in the associated stored value account) at POS (point of sale) terminals of participating merchants. In some cases, they may also be loaded over the internet, accessing the issuer's website and transferring funds from a credit card or banking account.

Thus, prepaid debit cards offer some convenience to consumers that do no have or do not qualify for traditional credit cards. However, if they are used frequently by the cardholder (and thus may need to be reloaded frequently), the cardholder will need to go to the card issuer (e.g., a bank) or to a participating merchant (e.g., at a clerk-assisted POS terminal). Very often card issuers do not want to increase their costs by having locations where cards can be loaded other than the issuer and participating merchants, since the operators of such additional locations will often require a fee or commission be paid for transactions originating from their terminals. Thus, the locations for loading the card are limited.

### BRIEF SUMMARY OF THE INVENTION

There is provided, in accordance with embodiments of the present invention, a network/system and method for permitting prepaid debit cards to be loaded at ATMs.

In one embodiment, a debit/credit network used for routing prepaid card transactions to a card issuer includes a BIN table with data reflecting whether a load transaction is permitted at a ATM, and the debit/credit network declines the transaction if the load transaction is not permitted.

In another embodiment, a method is provided for loading value on a prepaid debit card independently of a POS device. The method includes providing a plurality of ATMs, wherein transaction information is received at one of the ATMs when a prepaid card is to be loaded at that ATM, wherein the transaction information includes a card identifier read from the card, and wherein the card identifier includes a bank identification number (BIN) associated with the card issuer issuing the prepaid card. An ATM transaction processing system (acquirer) is provided for receiving the transaction information from the ATMs, and routing the transaction information to a debit/credit network that in turn routes the transaction information to the card issuer. A BIN table is provided at the debit/credit network, the BIN table for storing, in relation to each of a plurality of BINs, transaction permitted (TP) data indicating for that BIN whether load transactions at ATMs are permitted. A load transaction is declined at the debit/credit network if the TP data for the BIN in the card identifier indicates ATM load transactions are not permitted for that BIN. If the TP data for the BIN in the card identifier indicates load transactions are permitted, the transaction information is routed from the debit/credit network to the card issuer.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram of a network where prepaid debit cards may be loaded with monetary value at ATMs.

FIG. 2 is a more detailed diagram of one of the debit/credit networks seen in FIG. 1.

FIG. 3 illustrates the content of transaction information sent from the ATM to the debit/credit network.

FIG. 4 illustrates the content of the ATM Load BIN table seen in FIG. 2.

FIG. 5 is a flow diagram illustrating a process for loading prepaid cards at ATMs in the network of FIG. 1.

### DETAILED DESCRIPTION OF THE INVENTION

There are various embodiments and configurations for implementing the present invention. In general, embodiments provide systems and methods for loading prepaid debit cards at locations other than at merchant POS terminals. In described embodiments, the prepaid debit cards may be loaded at self-service ATMs (Automated Teller Machines) operated, e.g., by banks or other financial institutions that may not have issued the cards. The availability of ATMs to load prepaid debit cards increases the convenience of loading such cards for future purchase/withdrawal transactions. In the past, prepaid cards have been typically limited to loading at clerk assisted-POS locations (where e.g., purchase transactions could also be conducted) and to locations of the bank or other institution issuing the card.

Prepaid debit card transactions are conducted at terminals connected to the same financial networks that handle credit card transactions and traditional debit (bank and checking account card) transactions. Such networks include a merchant processor system (or acquirer) that collects and routes transactions to a debit/credit network. The debit/credit network then routes transactions to the banks that issue the credit or debit cards, where the transactions are posted to the underlying credit card account, bank account, or stored value account. In some embodiments herein, a BIN or bank identification number (that forms part of the card number of a prepaid card) is routed to the debit/credit network, where a BIN file determines whether the issuing bank has authorized loading the card at an ATM. If the issuing bank has not authorized such a load transaction, the debit/credit network returns a message declining the transaction, without passing the transaction information to the issuing bank for transaction approval. This last mentioned feature provides flexibility in permitting the issuer of prepaid debit cards to decide whether or not to permit its cardholders to load prepaid debit cards at an ATM (or other locations where such cards could not be loaded in the past). Because of consideration given to the costs that would be passed on to the issuer by the operator of the ATM where the loading would take place, each card issuer may decide individually whether or not to permit such load transactions, and such a decision can be easily and quickly implemented by the operator of the debit/credit network by changing the BIN table per the request of the issuer so as to permit (or thereafter discontinue) the use of ATMs for load transactions.

It should be appreciated that while the terms “bank identification number” and “BIN” are commonly used to refer the identifier in a card number for identifying the card issuer (and such terms are used for convenience herein), the card issuer need not be a “bank,” but rather could be any financial institution or other organization that issues prepaid debit cards. Thus, as used herein, “BIN” may refer to any kind of issuer identifier, whether the issuer is a bank or not.

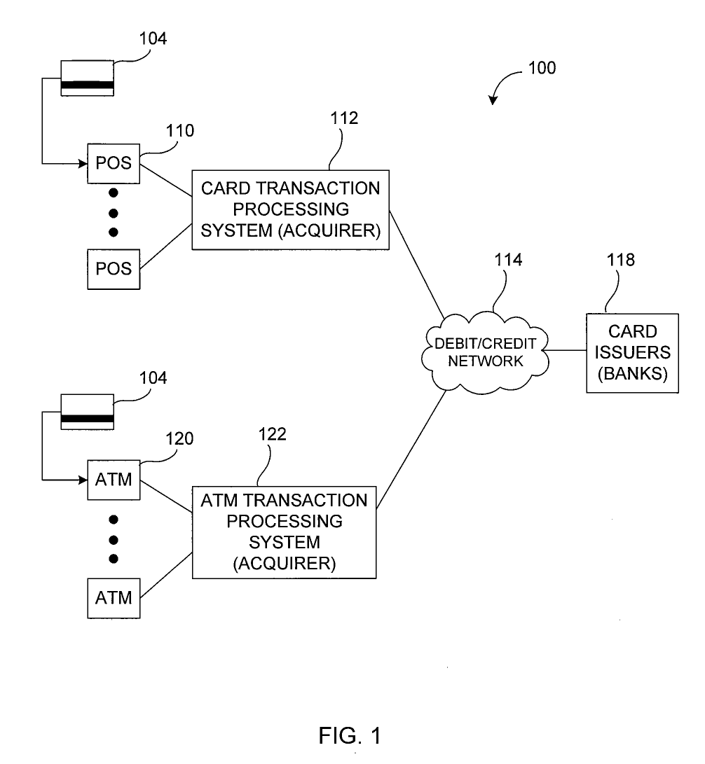

Referring now to FIG. 1, there is illustrated a network 100 in which electronic transactions may be conducted using various credit and debit cards 104. Transactions may be conducted at POS devices or terminals 110, which communicate with a card transaction processing system 112 (sometimes referred to as an “acquirer” or “acquiring system”), which in turn communicates through debit/credit networks 114 to card issuers 118. The card issuers may be banks or other financial institutions. Similarly, transactions may be conducted at a plurality of ATMs or similar self-service financial terminals 120, which communicate with an ATM transaction processing system 122 (also sometimes referred to as an “acquirer” or “acquiring system”), which in turn also communicates through the debit/credit networks 114 to the card issuers 118.

In operation (and as conventional), when a credit or debit card 104 is presented at a POS terminal 110 (say, to make a purchase), the terminal captures a card number from the card, captures transaction details (merchant identification, amount of transaction, etc.), and in some cases, captures a PIN entered by the consumer. The acquirer 112 collects and processes the transaction information from the POS terminals and routes that information to one of the debit/credit networks 114, which in turn routes the information to a card issuer for approval. The acquirer 112 and the debit/credit network 114 later reconcile accounts among the entities, with the network 114 receiving funds from the issuer for the amount of the transaction, and passing the amount on to the acquirer (after deducting a processing fee), and with the acquirer 112 passing payment on to the merchant (also after deducting a processing fee). The amounts are typically transferred using the electronic ACH (Automated Clearing House) system, with money transferred electronically to/from the accounts of the entities (merchant, acquirer, debit/credit network, and card issuer).

The acquirer 112 has a relationship with merchants from whom it receives transactions for processing, and will pass the transaction on to a selected debit/credit network 114 based on various criteria. For example, as part of every card number is a bank identification number (BIN) that is usually the first four digits of the card number and that identifies the card issuer. In some cases the card issuing bank may want to designate the debit/credit network to which card transactions are to be passed by acquirers, and this is accomplished by a BIN table stored in a database maintained by the acquirer (not shown in FIG. 1), with the BIN table providing for each BIN one or more networks 114 to where the transaction may be passed. The debit/credit networks 114 have relationships with the issuers 118 for processing transactions conducted using cards issued by that issuer. The debit/credit networks may be any known debit or credit network, such as STAR, PULSE, INTERLINK, MAESTRO, CU24, AFFN, ACCEL, EXCHANGE, NETS, SHAZAM, ATH, ALASKA OPTION, JEANIE, TEMPO PAYMENTS, CIRRUS, FASTBANK, INSTANT CASH, MINIBANK, MONEY NETWORK, PEAK, PLUS, NYCE, ALERT, VISA, MasterCard, DISCOVER, American Express, etc. However, the invention is not so limited, and any debit and/or credit network available in the geographic location of interest may be used in the context of the present invention.

In cases where the BIN table at the acquirer permits transactions to be sent to more than one debit/credit network, the acquirer can chose the network based on various factors such as “least cost routing,” i.e., the network path having the least costly fees. Systems for routing debit and credit card transactions to debit/credit networks (such as those employing least cost routing) are described, e.g., in commonly assigned U.S. patent application Ser. No. 11/682,856, entitled “Least Cost Network Routing for Electronic Transactions,” by Scott Peterson et al., filed Mar. 6, 2007, which is hereby incorporated by reference.

In a similar fashion, if a card 104 (e.g., debit or credit card) is presented at one of the ATMs 120 (e.g., to make a withdrawal), transaction information is passed through the acquirer 122 (which may be operated either by the bank operating the ATMs or another party serving as the acquirer/transaction processor). Based at least in part on a BIN table at the acquirer, such transaction is routed through one of the debit/credit networks 114 to the card issuer 118.

The networks and systems (and their operation) as thus far described are well known, and further details thereof can be found, e.g., in the aforementioned U.S. patent application Ser. No. 11/682,856.

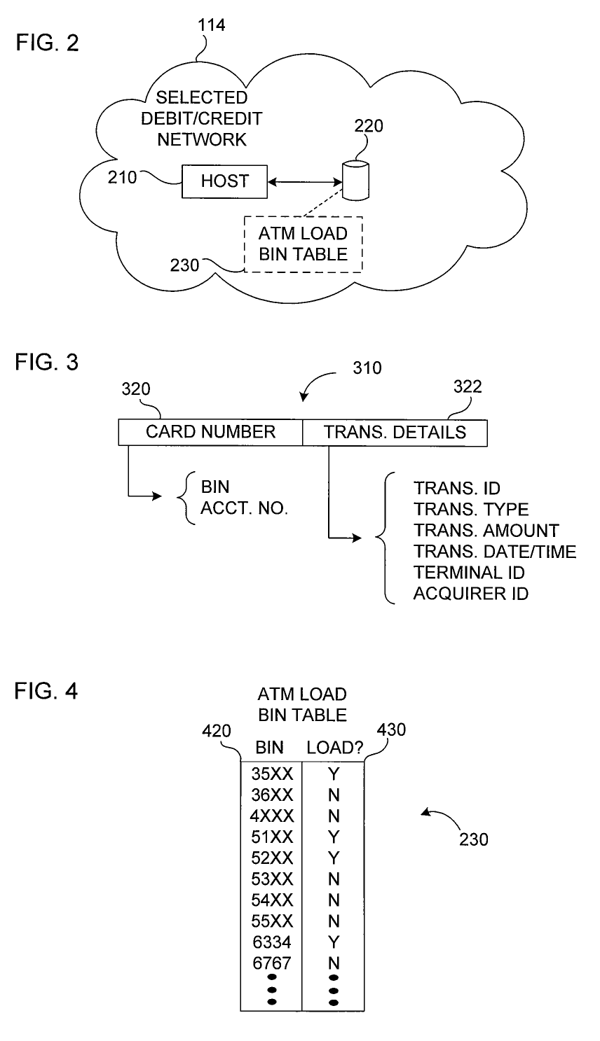

Embodiments of the invention will now be described, referring to FIGS. 2 through 5 in conjunction with FIG. 1. It is assumed, for purposes of FIG. 2, that a specific transaction (i.e., a request by a cardholder to load a prepaid debit card) has been made, and the ATM transaction processing system or acquirer 122 has routed the transaction to one debit/credit network 114 (e.g., as a result of a selection preference established by a BIN table within the acquirer 122, as described earlier). The debit/credit network 114 in FIG. 2 is illustrated as including a host 210 for managing transactions processed by the network, and a database 220 having various data files and tables used as part of the processing. In the illustrated embodiment, the database 220 includes (among other things) an ATM Load BIN table 230 that is used to determine whether the card issuer (corresponding to the BIN for the card being used) permits a load transaction at an ATM.

FIG. 3 illustrates the general content of a transaction message 310 that has been passed from the acquirer 112 or 122 to the network 114 when a card transaction has been requested at one of the POS terminals 110 or ATMs 120. As seen, the information in the transaction message includes a field 320 with data representing the card number (made up of the BIN and account number) and a field 322 with data representing transaction details. The transaction details include data reflecting a transaction identifier, the transaction type (here, a prepaid debit card load transaction), the transaction amount, the transaction date/time, the originating merchant/terminal ID, the acquirer ID, and so forth.

FIG. 4 illustrates exemplary content in the ATM Load Bin Table 230 seen in FIG. 2. In FIG. 4, the table 230 has a field 420 for storing data representing BINs, and a corresponding field 430 storing data indicating (Y/N) whether an ATM load transaction is permitted (for its corresponding BIN). The table 230 is accessed when a prepaid debit card is used at an ATM and a load transaction is requested. As illustrated, banks or financial institutions may have a single BIN or a BIN series. For example, the first entry seen in FIG. 4 for field 420 is a BIN series “35XX,” representing a single institution with multiple BINs, each beginning with the number “35”, and field 430 corresponding to that BIN series indicates that ATM load transactions are permitted (“Y”) for any BIN falling within that series. In another example, the last entry seen in field 420 is a single BIN “6767,” and field 430 corresponding to that BIN indicates that ATM load transactions are not permitted (“N”) for that BIN.

If banks or other card issuers may have multiple BINs, embodiments of the invention conveniently permit a card issuer to designate some prepaid cards (having one BIN) as “ATM load permitted”, and other prepaid cards from the same issuer (having a different BIN) as “no ATM load permitted.” Among other things, this allows the bank or card issuer to structure fees differently for different prepaid cards. For example, since a prepaid card where loads are permitted at ATMs might incur additional fees (e.g., from the operator of non-affiliated ATMs), such costs could be passed on only to the cardholders wanting that convenience.

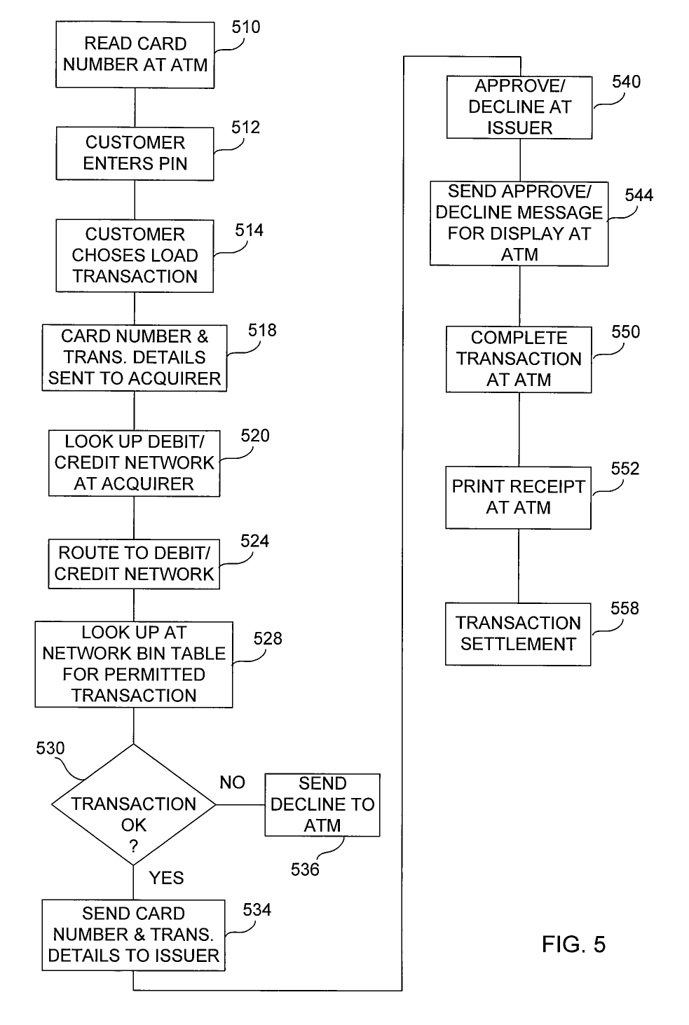

Referring now to FIG. 5, steps are illustrated for processing an ATM load requests for a prepaid debit card. The steps are implemented by programming and data within the host 210 and database 220 of debit/credit network 114 (FIG. 2), operating in conjunction with each of the ATMs 120, the acquirer 122 and the card issuers 118.

When a cardholder desires to load money onto a prepaid debit card, the card is inserted into one of the ATMs 120 and the card number is read (step 510). The cardholder is then requested to enter his/her PIN in order to authenticate the cardholder (step 512). Using menu options on the ATM screen, the cardholder selects a load (deposit) transaction (step 514), including the amount to be loaded onto the card. The ATM bundles transaction information in the form of a transaction or data message that includes the card number and transaction details (e.g., transaction type, ATM identifier, transaction amount) that is sent to the acquirer 122 (step 518). The acquirer 122 uses the BIN in the card number (alone or in conjunction with other factors, such as least cost routing) to look up or determine the debit/credit network 114 to which the transaction should be routed (step 520). The transaction is sent to that debit/credit network (step 524).

When the transaction information is received at the debit/credit network, it is determined to be a load request (from the transaction type data in the transaction details), and the host 210 uses the BIN from the card number to access the ATM Load BIN table 230 (step 528) to determine if a load transaction is permitted (step 530) by checking the data stored in table 230. Such data (field 430, FIG. 4) will have been previously established by the issuing bank and stored in table 430 by the operator of the network 114. If the transaction is permitted at step 530, the transaction information is routed to the card issuer (step 534). If not permitted, the transaction is declined and a message is returned to the ATM through the acquirer in order to display a decline message/screen to the cardholder (step 536).

If the transaction is permitted and routed to the issuer, the issuer then approves or declines the load transaction (step 540) based on account parameters or factors established by the issuer (e.g., whether the entered PIN is valid, whether the account is valid and in good standing, whether the amount is within the maximum permitted deposit, and so forth). An approve/decline message is sent from the issuer to the ATM through the network 114 and acquirer 122, and displayed to the cardholder (step 544). If the transaction has been approved, it is completed at the ATM (step 550), by the cardholder making a deposit (using a deposit envelope, bill acceptor, etc.), and a receipt is generated and printed at the ATM (step 552). The network 114 initiates settlement of the transaction (step 558), by crediting the issuer and debiting the acquirer.

The steps in the process seen in FIG. 5 are illustrative only, and some steps may be added or removed, and the order of steps changed. As one example only, the cardholder could load money onto the prepaid debit card using a second card (such as a credit card, bank debit card, etc.), in lieu of a deposit at the ATM. In such case, the card holder could insert the second card into the ATM (in response to screen prompts), enter a PIN for that second card, and transfer money from the account associated with the second card for the funds needed for loading the prepaid debit card.

While a detailed description of presently preferred embodiments of the invention has been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. In a network where prepaid debit cards may be used to conduct transactions at POS devices, where the cards have monetary value loaded thereon that is reflected at an associated stored value account maintained for a card issuer, a method for loading value on a prepaid debit card independently of a POS device, the method comprising:
providing a plurality of ATMs, wherein transaction information is received at one of the ATMs when a prepaid card is to be loaded at that ATM, wherein the transaction information includes a card identifier read from the card, and wherein the card identifier includes a bank identification number (BIN) associated with the card issuer issuing the prepaid card;
providing an ATM transaction processing system for receiving the transaction information from the ATMs, and routing the transaction information to a debit/credit network that in turn routes the transaction information to the card issuer;
providing a BIN table at the debit/credit network, the BIN table for storing, in relation to each of a plurality of BINs, transaction permitted (TP) data indicating for that BIN whether load transactions at ATMs are permitted;
declining a load transaction at the debit/credit network if the TP data for the BIN in the card identifier indicates ATM load transactions are not permitted for that BIN; and
routing the transaction information from the debit/credit network to the card issuer if the TP data for the BIN in the card identifier indicates load transactions are permitted.

2. The method of claim 1, wherein the transaction information further includes transaction details, and wherein the transaction details include the amount of the load transaction and a transaction identifier, and wherein the transaction identifier identifies the transaction as a prepaid load transaction at an ATM.

3. The method of claim 1, further comprising:
declining the transaction at the card issuer if the load transaction fails to meet parameters established by the card issuer.

4. The method of claim 3, wherein the transaction is declined at the card issuer if amount of the load transaction exceeds a permitted maximum deposit to the stored value account.

5. The method of claim 1, wherein the ATMs are at locations separate from the POS devices.

6. The method of claim 1, further comprising:
providing a routing BIN table at the ATM transaction processing system, the routing BIN table for storing data designating the debit/credit network to which the transaction information is to be routed.

7. The method of claim 1, wherein the transaction information further includes transaction details, and wherein the transaction details include the amount of the load transaction and a transaction identifier, wherein the transaction identifier identifies the transaction as a prepaid load transaction at an ATM, and wherein the transaction identifier is provided in response to a transaction selection made by a cardholder at the ATM.

8. The method of claim 1, further comprising:
providing a decline message from the debit/credit network to the ATM if the load transaction is declined at the debit/credit/network.

9. The method of claim 8, wherein the decline message from the debit/credit network is provided to the ATM without the transaction information being routed to the card issuer.

10. The method of claim 1, wherein the card identifier is a card number.

11. The method of claim 1, wherein the stored value account is not an FDIC insured account.

12. A system for loading prepaid debit cards, wherein where the prepaid debit cards may be used to conduct transactions at POS devices, where the cards have monetary value loaded thereon that is reflected at an associated stored value account maintained at a card issuer, and where the cards may be loaded independently of a POS device, the system comprising:
a plurality of ATMs, wherein transaction information is received at one of the ATMs when a prepaid card is to be loaded at that ATM, wherein the transaction information includes a card identifier read from the card at the ATM, and wherein the card identifier includes a bank identification number (BIN) associated with the card issuer issuing the prepaid card;
an ATM transaction processing system for receiving the transaction information from the ATMs; and
a debit/credit network for receiving the transaction information from the ATM transaction processing system and routing the transaction information to the card issuer;
wherein the debit/credit network includes a BIN table for storing, in relation to each of a plurality of BINs, transaction permitted (TP) data indicating for its BIN whether load transactions at ATMs are permitted;
wherein the debit/credit network accesses the BIN table in response to receiving the BIN in the card identifier from the ATM transaction processing system;
wherein the debit/credit network declines a load transaction if the TP data for the BIN in the card identifier indicates ATM load transactions are not permitted for that BIN; and
wherein the debit/credit network routes the transaction information from the debit/credit network to the card issuer if the TP data for the BIN in the card identifier indicates a load transactions is permitted.
